(19) United States
(12) Patent Application Publication
(10) Pub. No.: US 2006/0195856 A1
(43) Pub. Date: Aug. 31, 2006

(54) System and method for billing hotel guests for playing visual content

(75) Inventors: Gary B. Solomon, Dallas, TX (US); Mark B. Solomon, Norwood, MA (US)

Correspondence Address: SOLVISIONS TECHNOLOGIES INT'L INC., 82 ALBEMARLE ROAD, NORWOOD, MA, 02062, US

(73) Assignee: SOLVISIONS TECHNOLOGIES INT'L INC.

(21) Appl. No.: 11/066,826

(22) Filed: Feb. 25, 2005

(51) Int. Cl. H04N 7/16; H04N 7/18

(52) U.S. Cl. 725/5; 725/1; 725/83

(57) ABSTRACT

A system for billing hotel guests for playing visual content in a hotel room may be utilized by a hotel. The system may include a display system located in the hotel room. A computing system may be in communication with the display system and include a processor and memory. Software may be executed by the processor for displaying a menu on the display system to enable a hotel guest to select visual content to play on the display system. The software may further enable the hotel guest to select a payment option to apply charges for playing the visual content on a separate bill from a regular bill, where the regular bill includes hotel room rental charges.

### BACKGROUND OF THE INVENTION

Hotels generate revenue from hotel guests beyond renting hotel rooms, such as through providing ancillary hotel room services. Such hotel room services include, but are not limited to, enabling hotel guests to play visual content in hotel rooms directly on their room televisions. Visual content may include movies, sporting events, special events, video games, network access, documentaries, and so forth.

In the early years of providing visual content, hotels provided video cassette recorders in each room and rented video tapes to the guests. Playing visual content in hotel rooms has advanced in recent years due to “on-demand” or pay per view systems, such that a hotel guest, using a remote control, may now select visual content to play via a menu system on a television. Charges for viewing or using the visual content are applied to the room bill of the hotel guest.

Hotel guests typically include business and pleasure travelers. Business travelers often find themselves with free time in evenings and spend at least some of their free time watching visual content that either is free of charge (e.g., network or cable television) or costs money on a per viewing basis (e.g., per movie). Although business travelers enjoy watching visual content, many employers are unwilling to reimburse business travelers for personal room charges, such as telephone call charges or visual content charges, since these charges are considered unnecessary expenses. Business travelers are therefore reluctant to play visual content due to problems with submitting a hotel bill or receipt having visual content charges included thereon to their employers for payment or reimbursement. The problems associated with personal expenses may range, for example, from their employer's policy to (i) refuse reimbursement, (ii) become upset with such expenses, or (iii) suspect immoral behavior associated with the expenses. As a result, hotels are unable to maximize sales of products or services falling into the personal expense category, including visual content viewing revenue. The problems described above may also apply to pleasure travelers with respect to other family members, such as a spouse or parent.

### SUMMARY

To make hotel guests feel more comfortable in buying or renting personal expense products or services, the principles of the present invention provide for a hotel guest to select a billing option that allows them to be billed for personal expenses separately from room rental charges in a convenient manner. In a first embodiment, room rental charges are applied to a first bill and charges associated with playing visual content, for example, are applied to a second bill. The first and second bills may be applied to a single credit card, but separated into two bills so that a receipt for payment of the first bill may be submitted to an employer without listing the charges for viewing the visual content. In another embodiment, room rental charges are applied to a primary payment option (e.g., corporate credit card), and charges associated with playing visual content, for example, may be applied to a secondary payment option (e.g., the employee's personal credit card).

Accordingly, a hotel may utilize a system for billing hotel guests for playing visual content in a hotel room. The system may include a display system located in the hotel room. A computing system may be in communication with the display system and include a processor and memory. Software may be executed by the processor for displaying a menu on the display system to enable a hotel guest to select visual content to play on the display system. The software may further enable the hotel guest to select a billing option to apply charges for playing the visual content on a separate bill from a regular bill to which the hotel room rental charges are applied. Additionally, the software may enable the hotel guest to select a payment option to apply changes for playing the visual content on one of multiple forms of payment.

### BRIEF DESCRIPTION OF DRAWINGS

A more complete understanding of the method and apparatus of the present invention may be obtained by reference to the following Detailed Description when taken in conjunction with the accompanying Drawings wherein:

FIG. 1 is an illustration of a hotel room with a hotel guest watching visual content on a display system;

FIG. 2 is a block diagram of an exemplary system for playing visual content and an exemplary billing system in communication therewith in accordance with the principles of the present invention;

FIG. 3 is a block diagram of details of the system of FIG. 2, including a central controller and local controller for playing visual content;

FIGS. 4A-4E are images of exemplary menus displayed on a visual display in communication with a local controller of FIG. 3 for selecting visual content to play and for billing therefor;

FIG. 5 is a flow diagram of a process executed by the system of FIG. 2;

FIG. 6 is a flow diagram of a process describing operations performed by the billing system of FIG. 2;

FIG. 7 is a flow diagram of a process utilizing the billing system of FIG. 2 for finalizing and printing one or more bills and receipts associated with a hotel guest; and

FIG. 8 is an illustration of a hotel lobby with a hotel guest checking out of the hotel.

### DETAILED DESCRIPTION OF THE DRAWINGS

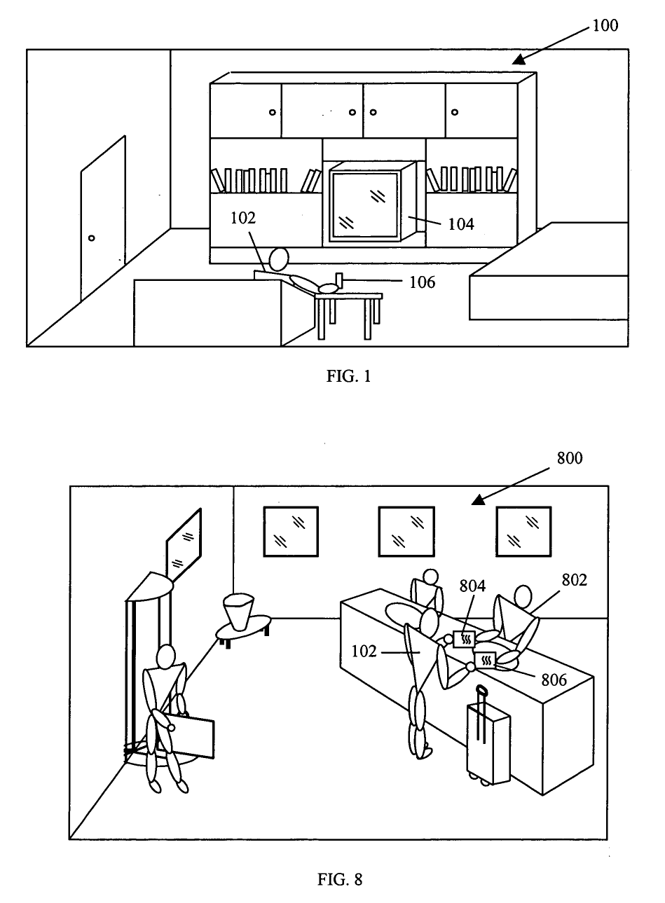

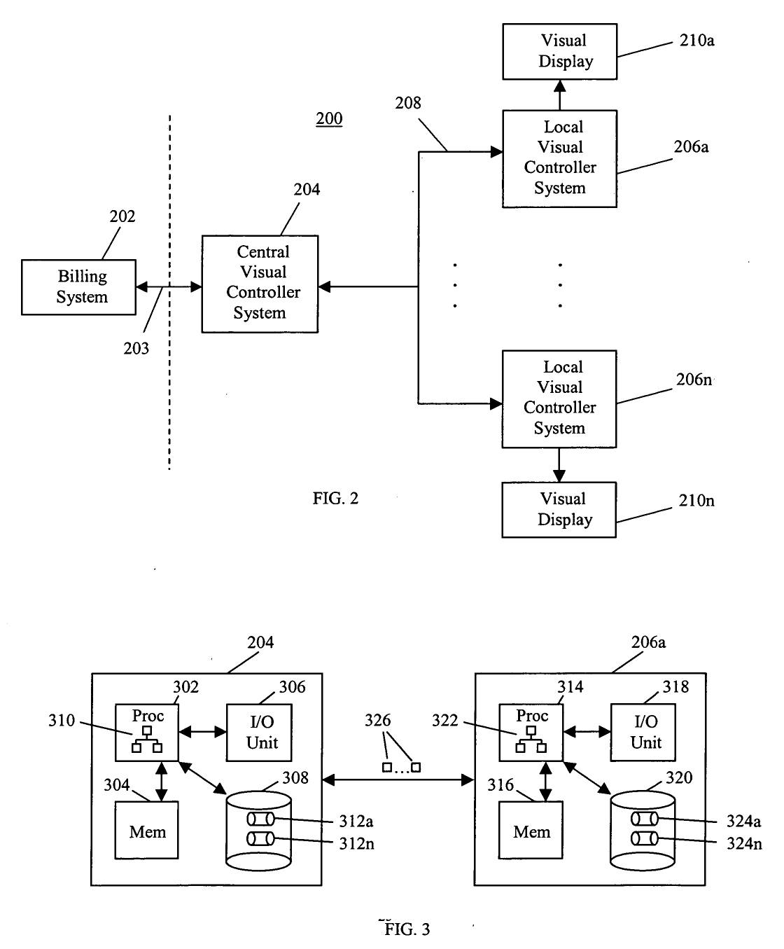

FIG. 1 is an illustration of a hotel room 100 with a hotel guest 102 watching visual content (e.g., a movie) on a display system 104. In one embodiment, the display system 104 is a television. The hotel guest 102 may use a remote control 106 to control the television and visual content being displayed thereon. In addition, the hotel guest 102 may use the remote control 106 to communicate with a local controller, described below in reference to FIG. 2, to control billing or payment options for paying for goods or services at the hotel. The goods or services may include viewing the visual content (e.g., movies), using various hotel amenities (e.g., spa), and consuming goods (e.g., mini-bar refreshments), for example.

A bill refers to an itemized list or statement of fees or charges. A billing option refers to a choice presented to a hotel guest for the hotel guest to select whether to receive one or more bills for payment. In the case of a hotel guest selecting to receive multiple bills, the multiple bills are referred to herein as a “regular bill” and a “separate bill.” A regular bill refers to a bill with an itemized list of fees or charges for rental of a hotel room. A separate bill refers to a bill with an itemized list of fees or charges that are not represented on the regular bill. Billing a hotel guest refers to a presenting a statement of fees or charges to a hotel guest for payment of goods or services consumed at the hotel. For example, hotel room rental charges may be itemized on a regular bill and charges for goods or services consumed by the hotel guest may be itemized on a separate bill. Each of the bills may be billed, charged, or applied to (used synonymously herein) any form of payment desired by the hotel guest.

Payment refers to an act of paying a bill. A payment option includes a choice that may be selected by a hotel guest for paying a bill. For example, the hotel guest may select a payment option to pay the hotel for fees or charges using one or more credit cards, debit cards, personal check, cash, or other form of payment.

A receipt refers to a record of payment of a bill by the hotel guest. Typically, a hotel guest receives a single receipt with an itemized list including hotel room rental charges and all other fees and charges for goods or services consumed at the hotel. The receipt is generally submitted to an employer for reimbursement. Sometimes a bill serves as a receipt for the hotel guest.

FIG. 2 is a block diagram of an exemplary visual display system 200 and exemplary billing system 202 in communication therewith via a local network 203. The local network 203 may be wired, wireless, or optical. The visual display system 200 may include a central visual controller system (“central controller”) 204 in communication with local visual controller systems (“local controllers”) 206a-206n (collectively 206) via a local network 208 that is wired, wireless, or optical. The local controllers 206 may be located in rooms of a hotel.

In one embodiment, the central controller 204 is located on the premises of the hotel. Alternatively, the central controller 204 may be remotely located on a wide area network (not shown), such as the Internet or intranet. In addition, the local controllers 206 may be located in each hotel room and electrically coupled to respective televisions or other visual displays 210a-210n (collectively 210). Alternatively, the local controllers 206 may be remotely located and in communication with the respective televisions in the hotel rooms. Still yet, the local controllers 206 may be integrated with respective visual displays 210. In yet other embodiments, the local controllers 206 may be integrated into the central controller 204 or a subset of local controllers 206 may be used to support multiple visual displays 210. In any case, hotel guests or users may interact with the local controllers 206 to select and play visual content and select billing and/or payment selections according to the principles of the present invention.

FIG. 3 is a block diagram showing details of the central controller 204 and local controllers 206a. The central controller 204 may include a processor 302 in communication with a memory 304, input/output unit 306, and storage unit 308. The processor 302 executes software 310 specifically designed for the visual content application described herein or be commercial software adapted for use in the visual content application described herein. One or more central repositories and/or databases 312a-312n (collectively 312) may reside on the storage unit 308. The repositories 312 may store visual content, such as movies, in a digital format, as understood in the art. Information associated with the visual content, such as titles, length, and preview may also be stored in the repositories 312. In addition, the repositories 312 may store general and statistical information associated with displaying the visual content. For example, the information associated with displaying the visual content may include the names of hotel guests who viewed which visual content on certain dates and times, gender of the hotel guests who viewed the visual content, how many times a particular visual content has been viewed, or any other statistical information of individuals or in the aggregate associated with the visual content and/or hotel guests. It should be understood that the same or similar statistical information may be stored as related to goods or services utilized or purchased at the hotel.

Continuing to refer to FIG. 3, the local controller 206a includes a processor 314 in communication with a memory 316, input/output (I/O) unit 318, and storage unit 320. The processor 314 may execute software 322. One or more local repositories and/or databases 324a-324n (collectively 324) may be stored on the storage unit 320. The repositories 324 may be utilized to store a subset of the information (e.g., visual content and information associated therewith) that is stored in the repositories 312 of the central controller 204. Statistical information may be generated and stored at the local controller 206a for communication to the central controller 204.

In operation, the software 310 operates to control operation of the central controller 204, such as handling service requests, commands, data, or other communications in the form of data packets 326 from the local controller 206a to receive a listing of visual content available for viewing and to communicate information to the billing system 202 (FIG. 2). The I/O unit 306 of the central controller 204 may communicate via the local networks 203 and/or 208 (FIG. 2) to the billing system 202 (FIG. 2) and local controller 206a, respectively. Information communicated to either system may be in the form of the data packets 326 or other signaling protocol, as understood in the art.

In one embodiment, the central controller 204 may receive a request from the local controller 206a via the I/O units 306 and 318 to download a visual content (e.g., video game) stored in the central repositories 312 to be stored in the local repositories 324 to enable a user (e.g., hotel guest 102 of FIG. 1) to view and/or interact with via a visual display 210a (FIG. 2) and local controller 206a. In another embodiment, the software 310 of the central controller 204 may respond to a request by the billing system 202 or automatically deliver a notification to the billing system 202 with information regarding recently played visual content by a particular local controller 206a or multiple local controllers 206. According to the principles of the present invention, a billing option and/or payment option selection may be selected by a user of the local controller 206 and may be stored in the local repositories 324 and/or central repositories 312 for delivery to the billing system 202 at checkout or other suitable time. The billing system 202 uses the billing or payment option selected by the user so that the proper form of payment (e.g., particular credit card) or billing option (e.g., separate bill) may be used to bill the hotel guest at checkout, for example.

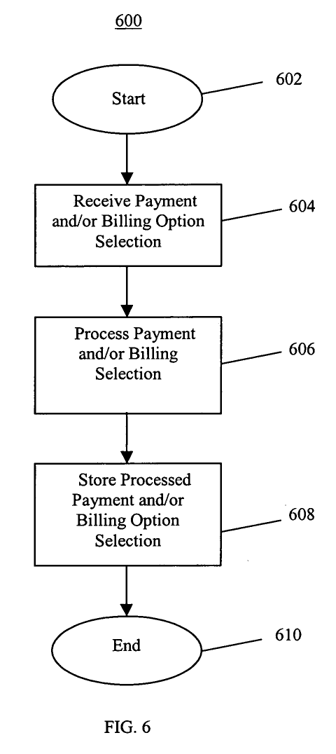

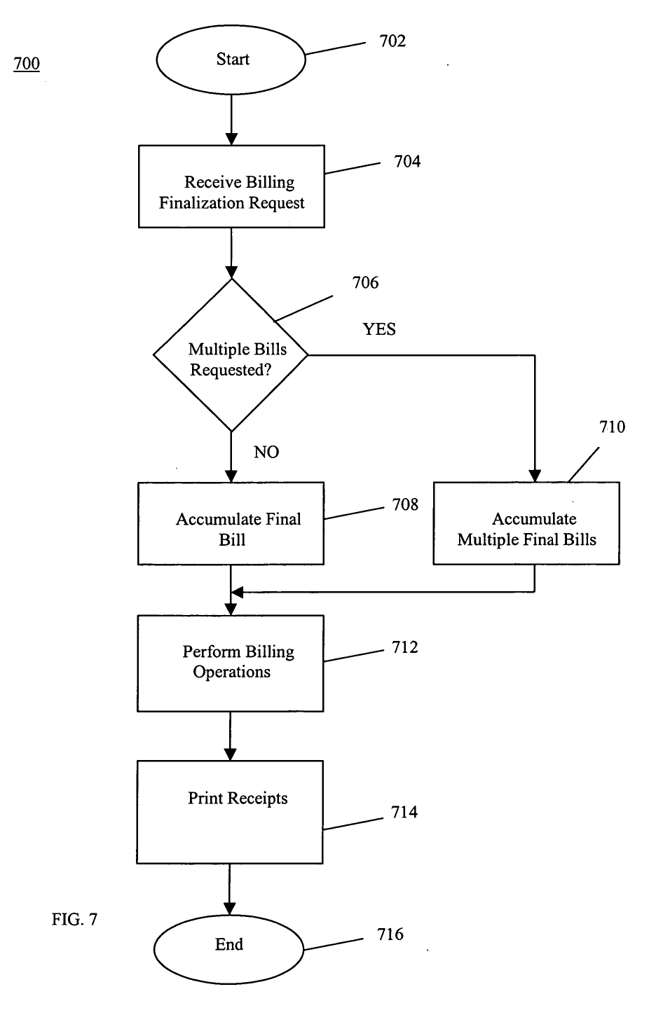

The billing system 202 of FIG. 2 may include the same or similar structure as the central controller 204, but execute software particular to a payment or billing system, as understood in the art. The software executed by the billing system 202 may maintain charges accumulated by a hotel guest and be capable of applying the charges to one or more payment options (e.g., multiple credit cards) and print multiple bills with different charges selected to be applied to each, as described below in reference to FIGS. 6 and 7.

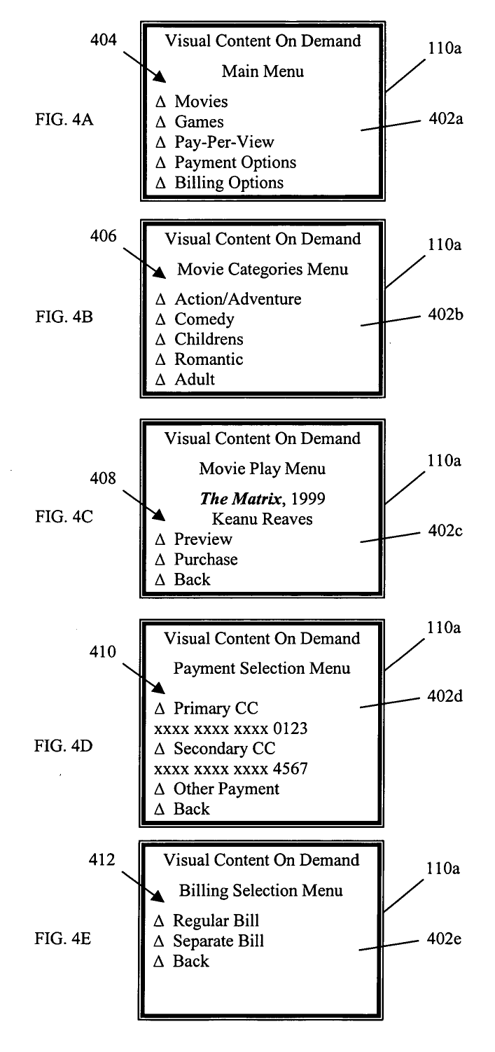

FIGS. 4A-4E are screen views of exemplary menus 402a-402e (collectively 402) displayed on the visual display 210a of FIG. 2. In one embodiment, the menus 402 may be displayed on the visual display 210a (FIG. 2) by the processor 314 (FIG. 3) of the local controller 206a (FIG. 2) accessing data stored in the storage unit 320 (FIG. 3) or elsewhere and rendering content display options 404. A user may select one of the content display options 404 by utilizing a remote control device 106 (FIG. 1) in communication with the local controller 206a, as understood in the art.

FIG. 4A is a screen view of an exemplary main menu 402a to enable a user of the visual display system 200 to select visual content from multiple visual content display options 404. The main menu 402a may provide the user with a number of different options from which to select, including, but not limited to “movies,” “games,” “pay-per-view,” “payment options,” “billing options,” and so forth.

FIG. 4B is a screen view of an exemplary movie categories menu 402b, where the movie types may include typical movie categories 406, as understood in the art. For example, the movie categories 406 may include “action/adventure,” “comedy,” “childrens,” “romantic,” “adult,” or other categories. The movie categories 406 may additionally and/or alternatively include movies categorized by movie studio or any other categorization scheme. A user may select one of the movie category options, and a submenu or movie listing may be provided for the user to select a movie from a number of movies in that category or further subcategory.

FIG. 4C is a screen view of a movie purchase menu 402c that includes “preview,” “purchase,” and “back” menu options 408. A user may select the “preview” option to play a preview trailer, “purchase” option to play and be charged for playing the movie, or “back” option to go back to the movie categories menu 402b. In addition, the screen view may include information associated with a selected movie, including title, names of actors, date of creation, description, and so forth.

FIG. 4D is a screen view a payment selection menu 402d that may be generated and displayed in response to selection of a payment option in the main menu 402a and/or by selecting the purchase option in the movie purchase menu 402c. The payment selection menu 402d may include a number of payment selection options 410. For example, the payment selection options 410 may include a number of options, including one or more credit cards (e.g., “primary CC” and “secondary CC”), debit cards (not shown), or other payment. In addition, another payment selection may be included in the payment selection options 410, where the user may choose to pay for playing the visual content in the form of cash or otherwise.

The payment selection options 410 may be established by the user (e.g., hotel guest) while checking into the hotel by providing both a primary credit card and secondary credit card to a hotel front desk employee. Alternatively, the credit cards may be stored on the billing system 202 (FIG. 2) for hotel guests who frequent the hotel as a courtesy to reduce check-in time. The hotel front desk employee may enter the different credit cards into the billing system 202 and/or central controller 204 (FIG. 2) to enable selection by the hotel guest via the local controller 206a (FIG. 2). In one embodiment, the central controller 204 requests the available payment options for a hotel guest from the billing system 202 in response to a request from a local controller 206a receiving a selection request to view visual content from the respective hotel guest. In another embodiment, the local controller 206a may prompt the hotel guest to enter credit card information.

FIG. 4E is a screen view of a billing selection menu 402e. The billing selection menu 402e includes a number of billing options 412, including “regular bill” and “separate bill.” Selection of the “regular bill” option causes the charges for playing visual content to appear on the regular bill. As understood in the art, the charges listed on the regular bill may simply be “movie” rather than the title of the movie or other visual content. The “separate bill” option causes the charges for playing the visual content to appear on a separate bill from a regular bill from which the hotel guest may submit a receipt to his or her employer for reimbursement. In one embodiment, the “regular bill” may be a default option. Alternatively, the “separate bill” may be a default option. Still yet, the options may be part of an initial set-up option menu to minimize the number of selection menus. In either case, a parameter may be stored in the billing system 202 and/or central system 204 representative of the default option for use in billing the hotel guest.

TABLE I below illustrates an exemplary regular bill that includes typical hotel and hotel guest information. Also included on the regular bill is a bill number. Charges accumulated during the stay of the guest, including room rental, spa, meals, and other charges, may be included on the regular bill. If the hotel guest views visual content, then the hotel guest may select to apply the charges for viewing the visual content to the regular bill, separate bill, or different payment option via the visual display system 200 (FIG. 2). In the case of TABLE I, either (i) no visual content was purchased or (ii) visual content was purchased and selected by the hotel guest to be billed on a separate bill or to a separate credit card. If visual content was viewed and the hotel guest selected to apply the charges for viewing the visual content to a separate bill, the charges are not listed on the regular bill. It should be understood that all charges can be specified for either bill, including the spa and meal that are listed on the bill of TABLE I.

TABLE I
Exemplary Regular Hotel Bill

| | |
|---|---|
| Greg Smith | Charter Hotels |
| Los Angeles, CA | Preferred #ABCD0123 |
| Arrival: Jul. 14, 2005 | Room: 645 |
| Departure: Jul. 16, 2005 | Agent: Tom |
| Bill #9876543 | Charter Hotel, Dallas, TX |

| Date | Room | Description | Charges |
|---|---|---|---|
| Jul. 14, 2005 | 645 | Room Rental | $129.50 |
| Jul. 14, 2005 | 645 | Spa | $60.00 |
| Jul. 14, 2005 | 645 | Meal - Dinner | $48.60 |
| Jul. 15, 2005 | 645 | Room Rental | $129.50 |
| Total: $367.60 | | | |

Your charges will be applied to the credit card ending in 0123.

TABLE II is an exemplary separate bill that may include the same hotel and hotel guest information as the regular bill. The separate bill may be generated if the hotel guest selects to apply the charges for playing the visual content to a separate bill from the billing selection menu 402e (FIG. 4E) of the visual display system 200 (FIG. 2). The bill number may be the same as the regular bill of TABLE I, but the charges may be applied to the credit card separately from those of the regular bill on the same credit card. By billing separately and printing the charges on a separate receipt, the hotel guest 102 (FIG. 1) may submit the regular receipt to an employer for reimbursement without submitting the charges for playing the visual content or for generating other personal charges while at the hotel. By having the billing and payment options available to the hotel guest 102 in accordance with the principles of the present invention, a more comfortable travel and reimbursement situation is provided to the hotel guest 102. By printing the charges for playing the visual content on a separate receipt, the problems of conventional visual display systems are avoided.

TABLE II
Exemplary Separate Hotel Bill

| | |
|---|---|
| Greg Smith | Charter Hotels |
| Los Angeles, CA | Preferred #ABCD0123 |
| Arrival: Jul. 14, 2005 | Room: 645 |
| Departure: Jul. 16, 2005 | Agent: Tom |
| Bill #9876543 | Charter Hotel, Dallas, TX |

| Date | Room | Description | Charges |
|---|---|---|---|
| Jul. 14, 2005 | 645 | Visual Content - Movie | $9.95 |
| Jul. 15, 2005 | 645 | Visual Content - Internet | $4.95 |
| Jul. 15, 2005 | 645 | Visual Content - Movie | $13.95 |
| Jul. 15, 2005 | 645 | Visual Content - Video Game | $5.95 |
| Total: $28.85 | | | |

Your charges will be applied to the credit card ending in 0123.

In addition to including visual content on a separate bill, the hotel guest 102 may utilize the local controller 206 to transfer or apply other hotel charges to a separate bill or secondary credit card from a primary credit card. For example, a business traveler traveling with his or her spouse may utilize a business credit card for room charges, but utilize a personal credit card for spa, room service, and playing visual content charges, thereby enabling the hotel guest to expeditiously check out using the local controller 204 or via a traditional front desk checkout. It should be understood that if a secondary credit card is selected for visual content and/or other charges to be applied, a separate bill having a different bill number may be generated.

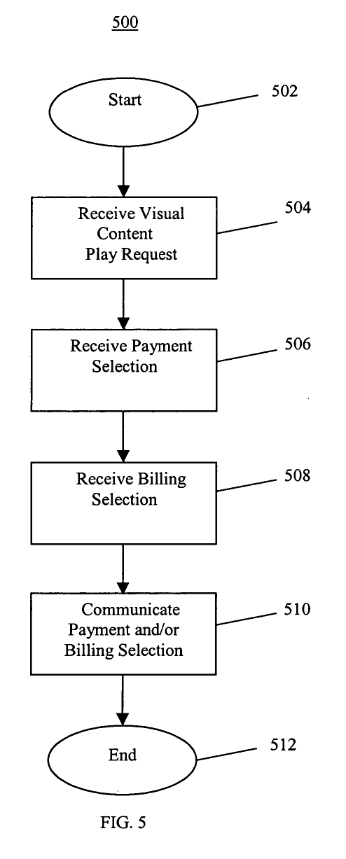

FIG. 5 is a flow diagram describing a process 500 for a user of a visual display system, such as the visual display system 200 of FIG. 2 to select visual content to view and to select the charges to be applied to a separate bill and/or different form of payment. The process starts at step 502. At step 504, a visual content play request is received. In one embodiment, a local controller, such as local controller 206a (FIG. 2), receives the request from a hotel guest via a remote control as understood in the art. At step 506, a payment selection is received. The payment selection may include a selection for applying payment to a primary credit card, secondary credit card, debit card, or other form of payment. At step 508, a billing selection may be received. As described with respect to FIG. 4E, the billing selection may include applying charges for playing the selected visual content to a regular or separate bill. At step 510, the payment and/or billing selection may be communicated to a billing system to perform the selected functions, which may include applying the charges for playing the visual content to a particular form of payment and/or include the charges on a separate bill from a regular bill that includes the hotel room rental charges. The communication may be from the central controller 204 (FIG. 2) or local controller 206a (FIG. 2) to the billing system 202 (FIG. 2) as described in connection to FIGS. 2 and 3. The process ends at step 512. It should be understood that all or some of the steps of FIG. 5 may be provided to the hotel guest or that the steps may be rearranged in accordance with the principles of the present invention.

FIG. 6 is a flow diagram for a process 600 describing operations performed at the billing system 202 (FIG. 2) for implementing the payment and/or billing selections according to the principles of the present invention. The process 600 starts at step 602. At step 604, a payment and/or billing option selection is received. At step 606, the payment and/or billing option selection is processed. In processing the payment and/or billing option selection, a record of a database or repository may be accessed and updated to reflect the selected option(s). Charges for playing the visual content may be received and processed simultaneously with the selected option(s) by the billing system. At step 608, the processed payment and/or billing option selection may be stored. By storing the payment and/or billing options selected by the hotel guest, the billing system 202 may bill the hotel guest accordingly at checkout. The process 600 ends at step 610.

TABLES IIIA and IIIB show two records of a database associated with a user of a hotel room visual display system. The records may include a number of different parameters associated with the user. For example, the database may include information included at the header of the bill shown in TABLES I and II, such as name, address, room number, arrival date, departure date, and preferred number. Other information in the records may include parameters related to charges for applying to a user's bill. The charges may include room rental, playing of visual content, room service, spa, and other charges related to the purchase of goods or services at a hotel. The charges may be added to and stored in the user's record at the billing system 202 (FIG. 2) or stored in the central controller 204 (FIG. 2) for later delivery to the billing system 202. It should be understood that other parameters and information associated with charges' generated by a user may be stored and applied.

TABLE IIIA
Exemplary Hotel Guest Record

| NAME | ADDRESS | ROOM | ARRIVAL | DEPARTURE | PREFERRED # |
|---|---|---|---|---|---|
| Greg Smith | Los Angeles, CA | 645 | Jul. 14, 2005 | Jul. 16, 2005 | ABCD0123 |

| | | | | SECONDARY | | SELECTED | | | |
|---|---|---|---|---|---|---|---|---|---|
| DATE | DESCRIPTION | PRIMARY CC | EXP | CC | EXP | CC | BILL # | BILL TYPE | AMOUNT |
| Jul. 14, 2005 | Room Rental | 5678 9567 | September 2005 | N/A | N/A | Primary | 9876543 | Regular | $129.50 |
| | | 2345 0123 | | | | | | | |
| Jul. 14, 2005 | Spa | 5678 9567 | September 2005 | N/A | N/A | Primary | 9876543 | Regular | $60.00 |
| | | 2345 0123 | | | | | | | |
| Jul. 14, 2005 | Meal - Dinner | 5678 9567 | September 2005 | N/A | N/A | Primary | 9876543 | Regular | $48.60 |
| | | 2345 0123 | | | | | | | |
| Jul. 14, 2005 | Visual Content - | 5678 9567 | September 2005 | N/A | N/A | Primary | 9876543 | Separate | $9.95 |
| | Movie | 2345 0123 | | | | | | | |
| Jul. 15, 2005 | Room Rental | 5678 9567 | September 2005 | N/A | N/A | Primary | 9876543 | Regular | $129.50 |
| | | 2345 0123 | | | | | | | |
| Jul. 15, 2005 | Visual Content - | 5678 9567 | September 2005 | N/A | N/A | Primary | 9876543 | Separate | $4.95 |
| | Internet | 2345 0123 | | | | | | | |
| Jul. 15, 2005 | Visual Content - | 5678 9567 | September 2005 | N/A | N/A | Primary | 9876543 | Separate | $13.95 |
| | Movie | 2345 0123 | | | | | | | |

TABLE IIIB
Exemplary Hotel Guest Record

| NAME | ADDRESS | ROOM | ARRIVAL | DEPARTURE | PREFERRED # |
|---|---|---|---|---|---|
| Roxanne Brown | Dallas, TX | 946 | Aug. 17, 2005 | Aug. 18, 2005 | CDEF3456 |

| | | PRIMARY | | SECONDARY | | SELECTED | | | |
|---|---|---|---|---|---|---|---|---|---|
| DATE | DESCRIPTION | CC | EXP | CC | EXP | CC | BILL # | BILL TYPE | AMOUNT |
| Aug. 17, 2005 | Room Rental | 0123 4567 | February 2006 | 6789 0123 | July 2006 | Primary | 2345678 | Regular | $139.95 |
| | | 8901 2345 | | 4567 8901 | | | | | |
| Aug. 17, 2005 | Visual Content- | 0123 4567 | February 2006 | 6789 0123 | July 2006 | Secondary | 2345679 | Regular | $13.95 |
| | Movie | 8901 2345 | | 4567 8901 | | | | | |
| Aug. 17, 2005 | Meal - | 0123 4567 | February 2006 | 6789 0123 | July 2006 | Secondary | 2345679 | Regular | $17.50 |
| | Room Service | 8901 2345 | | 4567 8901 | | | | | |
| Aug. 17, 2005 | Food - | 0123 4567 | February 2006 | 6789 0123 | July 2006 | Secondary | 2345679 | Regular | $3.50 |
| | Mini Bar | 8901 2345 | | 4567 8901 | | | | | |
| Aug. 18, 2005 | Parking - | 0123 4567 | February 2006 | 6789 0123 | July 2006 | Primary | 2345678 | Regular | $24.95 |
| | Overnight | 8901 2345 | | 4567 8901 | | | | | |

As shown in TABLES IIIA and IIIB, the parameters associated with billing may include multiple credit cards (i.e., primary credit card (CC) and secondary credit card) to enable a user to selectively apply charges for playing visual content, for example, to one of the credit cards. Additionally, a bill number and bill type (e.g., regular and separate) parameters may be included. However, the bill number may not be applied until the user hotel guest checks out of the hotel.

The “Greg Smith” record in TABLE IIIA illustrates the hotel guest applying visual content charges to the same credit card as the hotel room rental charges are to be applied, but to a separate bill from the regular bill, which normally includes room charges. The separate bill is charged separately to the same credit card as the charges on the regular bill, thereby enabling a receipt of payment of the regular bill to be submitted for reimbursement from an employer as a business expense without non-reimbursable charges, assuming that the credit card is a personal credit card as opposed to a corporate credit card.

The “Roxanne Brown” record in TABLE IIIB is an example of a hotel guest providing the hotel with multiple credit cards, a primary credit card (e.g., corporate credit card) for room charges and secondary credit card (e.g., personal credit card) for various incidental charges as selected by the hotel guest via the local controller 204 (FIG. 2), for example. Alternatively, another user selection system, such as a voice interface or portal via a telephone network for applying charges to a primary and secondary credit card, may be facilitated by the central or local visual controller systems 204 or 206. As shown, the charges are selectively applied to a primary and secondary credit card. Each charge is applied to a “regular” bill for the respective credit cards, but placed on separate bills because of being charged to separate credit cards. It should be understood that the record may include other forms of payment and charges applied thereto in accordance with the principles of the present invention.

FIG. 7 is a flow diagram describing a process 700 for finalizing and printing one or more receipts associated with a hotel guest. The process 700 starts at step 702. At step 704, a request for a billing finalization of a hotel guest is received by a billing system, such as the billing system 202 of FIG. 2. At step 706, a determination is made as to whether multiple bills were requested. The determination may be made based on one or more parameters stored to perform billing and payment operations by the billing system. If not, one final bill with all charges is accumulated at step 708. If multiple bills were requested, either to a single or multiple credit cards, then the multiple bills are accumulated at step 710. In another embodiment, the steps 706-710 may be combined, and the bill(s) may be processed without performing a query. In accumulating the bill(s), the charges included on the bill(s) are added and taxes and other fees are applied to determine a total to be applied to the credit card(s) or other form of payment of the hotel guest.

At step 712, billing operations are performed. The billing operations may include applying the total charges on the bill(s) to one or more credit cards or other forms of payment. At step 714, receipts of payment of the bill(s) are printed for the hotel guest. The process 700 ends at step 716.

Another embodiment of the visual content display system 200 (FIG. 2) may enable a user to display all or some of the charges for goods and services purchased during a hotel stay and enable the user to individually select a billing and/or payment option for each charge. Accordingly, this process of enabling a user to display all or some of the charges may be selectively performed via a selection option from the main menu (FIG. 4A) or via a final billing process for checkout utilizing a local controller 206a (FIG. 2).

Although the description has been directed toward systems and methods for use at hotels, the principles of the present invention may also be applied to various forms of transportation, such as airplanes, trains, automobiles, and ships. More generally, the principles of the present invention may be employed in any situation in which charges or expenses can be separated in a user selectable manner for payment or billing as described above. For example, the principles of the present invention may be applied to use other forms of communication, including the Internet, cable television, satellite, and other wireless-to-home communications for display of visual content on electronic devices (e.g., television and computer) and wireless-to-mobile devices (e.g., mobile telephones, personal digital assistants, and wireless entertainment devices). For example, standard cable television may support a regular monthly cable bill and a separate bill for viewing “on-demand” or pay per view movies.

FIG. 8 is an illustration of a hotel lobby 800 showing the hotel guest 102 (FIG. 1) checking out of the hotel. In this example, the hotel guest 102 selected to be billed separately for use of the Internet and viewing of visual content (see TABLE IIIA). Accordingly, a front desk attendant 802 bills the hotel guest 102 twice on the same credit card (e.g., 5678 9567 2345 0123) and prints two separate receipts 804 and 806. It should be understood that the receipts 804 and 806 may have the same bill number (e.g., 9876543) or different bill numbers. The hotel guest 102 may thereafter submit the hotel receipt 804 to his employer for reimbursement without concern that the employer will reject reimbursing him for using the Internet and watching visual content or question his moral integrity. Alternatively, the front desk attendant 802 or other hotel employee may print the receipts 804 and 806 according to the billing selections (e.g., separate billing for Internet usage and visual content viewing) made by the hotel guest 102 and slide the receipts under the room door of the hotel guest 102 for an express checkout, as understood in the art.

The previous description is of at least one embodiment for implementing the invention, and the scope of the invention should not necessarily be limited by this description. The scope of the present invention is instead defined by the following claims.

What is claimed is:

1. A system for billing hotel guests for playing visual content, said system comprising:
a display system located in a hotel room;
a computing system in communication with said display system and including a processor and memory; and
software executed by the processor for displaying a menu on said display system to enable a hotel guest to select visual content to play on said display system, said software further operable to enable the hotel guest to select a billing option to apply charges for playing the visual content on a separate bill from a regular bill, the regular bill including hotel room rental charges.

2. The system according to claim 1, wherein said software executed by the processor is further operable to enable the hotel guest to select a payment option to apply the charges for playing the visual content to one of a plurality of forms of payment.

3. The system according to claim 2, wherein said software executed by the processor is further operable to enable the hotel guest to enter credit card information.

4. The system according to claim 1, wherein said computing system is co-located with said display system.

5. The system according to claim 1, wherein said computing system is in communication with a second computing system, said software further operable to communicate the selected billing option to the second computing system.

6. The system according to claim 5, wherein the second computing system is a central controller utilized to distribute the visual content to hotel rooms.

7. The system according to claim 5, wherein the second computing system is a hotel billing system.

8. The system according to claim 1, wherein said software executed by the processor is further operable to enable the hotel guest to select charges other than those for playing visual content to be applied to the separate bill.

9. A method for billing hotel guests for playing visual content, said method comprising:
receiving a request from a hotel guest in a hotel room for playing visual content;
prompting the hotel guest in the hotel room with multiple billing options via a display system;
receiving, via the display system, a selected billing option from the hotel guest in response to said prompting; and
communicating the selected billing option of the hotel guest for billing the hotel guest on a separate bill from a regular bill for playing the visual content, the regular bill including charges for rental of the hotel room.

10. The method according to claim 9, wherein said receiving the request is performed by a local controller in communication with the display system.

11. The method according to claim 10, wherein said communicating the selected billing option includes communicating the selected billing option from the local controller to a billing system of the hotel.

12. The method according to claim 10, further comprising printing a separate receipt for the separate bill from a receipt for the regular bill.

13. The method according to claim 9, further comprising:
prompting the hotel guest in the hotel room with multiple payment options;
receiving a selection of a payment option in response to said prompting the hotel guest with multiple payment options; and
communicating the selected payment option for billing the hotel guest in accordance with the selected payment option.

14. A system for billing a hotel guest for playing visual content, said system comprising:
a computing system utilized by a hotel having a processor and memory;
software executed by the processor for billing a hotel guest for rental of a hotel room and for other charges;
a storage unit in communication with the computing unit that stores a hotel billing record associated with hotel guests, the hotel billing record including a billing option parameter operable to bill the hotel guest separately for hotel room rental charges and visual content playing charges; and
a printing system in communication with said computing system operable to print receipts in accordance with the billing option parameter.

15. The system according to claim 14, wherein the hotel billing record further includes a payment option parameter operable to bill the hotel guest for playing the visual content by a particular form of payment.

16. The system according to claim 15, wherein the payment option parameter includes at least one of a primary credit card, secondary credit card, cash, and debit card.

17. The system according to claim 14, wherein said software is further operable to set the billing option parameter in response to a selection of a billing option by the hotel guest.

18. A method for billing a hotel guest, said method comprising:
establishing a hotel billing record for a hotel guest, the hotel billing record including a billing option parameter for playing visual content;
setting the billing option parameter for billing charges for playing the visual content; and
billing the hotel guest in accordance with the billing option parameter, the billing option parameter being utilized to separately bill the hotel guest for charges for playing the visual content from billing for rental of the hotel room.

19. The method according to claim 18, further comprising:
printing a receipt for rental of the hotel room on a first receipt; and
printing a receipt for playing of the visual content on a second receipt.

20. The method according to claim 18, further comprising storing a payment option selected by the hotel guest as a payment option parameter in the hotel billing record for billing the hotel guest for playing the visual content by a particular form of payment.

21. The method according to claim 18, wherein the particular form of payment is a credit card.

22. The method according to claim 18, wherein said setting the billing option parameter is performed in response to receiving selection of a billing option by the hotel guest.
